(19) United States
(12) Patent Application Publication
(10) Pub. No.: US 2017/0330294 A1
(43) Pub. Date: Nov. 16, 2017

(54) ELECTRIC POWER SUPPLY AND DEMAND CONTROL APPARATUS, ELECTRIC POWER SUPPLY AND DEMAND CONTROL METHOD, AND NON-TRANSITORY STORAGE MEDIUM

(71) Applicant: NEC Corporation, Tokyo (JP)

(72) Inventors: Togo MURAKAMI, Tokyo (JP); Tatsushi HAMADA, Tokyo (JP); Takashi KOBAYASHI, Tokyo (JP); Tsuyoshi SATOU, Tokyo (JP)

(21) Appl. No.: 15/525,507

(22) PCT Filed: Sep. 14, 2015
(86) PCT No.: PCT/JP2015/075967

§ 371 Date: May 9, 2017

(30) Foreign Application Priority Data
Nov. 10, 2014 (JP) 2014-227822

(51) Int. Cl. G06Q 50/06; G06F 1/26; G05B 15/02; H02J 3/00; G06F 1/32

(52) U.S. Cl. CPC G06Q 50/06; H02J 3/008; G06F 1/3287; G05B 15/02; G06F 1/263; G06F 1/266

(57) ABSTRACT

Provided is an electric power supply and demand control apparatus (10) including a remaining battery level acquisition unit (11) and a setting unit (12), in order to solve the aforementioned problems. The remaining battery level acquisition unit (11) acquires remaining battery level information indicating a remaining battery level of a storage battery of a consumer. The setting unit (12) sets an expectation value of a reduction in power purchase from a system performed by the consumer, on the basis of the remaining battery level information acquired by the remaining battery level acquisition unit (11). For example, a high expectation value is set for a consumer whose storage battery has a large remaining battery level. According to the present invention, it is possible to create an appropriate plan of a request for a reduction in a power purchase quantity, on the basis of the expectation value of the reduction in power purchase for each consumer determined on the basis of the remaining battery level of a storage battery of the consumer.

### TECHNICAL FIELD

The present invention relates to a so-called demand response (DR), and particularly relates to an electric power supply and demand control apparatus, an electric power supply and demand, control method, and a program.

### BACKGROUND ART

A technique associated with the present invention is disclosed in Patent Documents 1 to 6.

Patent Document 1 discloses a reserve power calculation apparatus that infers a difference between a prediction value of power consumed by a consumer and reference power consumption calculated on the basis of the day's air temperature or the like, as a reducible margin of power consumption performed by the consumer.

Patent Document 2 discloses an operation management apparatus including a first operation plan creation unit that calculates a power demand prediction value indicating power consumed by a load on a prediction date, a storage unit that stores a target value of demand power, and a second operation plan creation unit that creates an operation plan so as to lower an output of the load in a case where the power demand prediction value within a demand interval exceeds the target value.

Patent Document 3 discloses a power generation quantity prediction system that collates a variation pattern to be predicted at a collation time slot of a power generation quantity of a solar power generation apparatus which is a prediction target with each peripheral variation pattern at collated time slot before the collation time slot of power generation quantity statuses of a plurality of peripheral power generation apparatuses, determines the power generation apparatus having the peripheral variation pattern which is approximate to the variation pattern to be predicted, as a windward power generation apparatus, and predicts a predicted power generation quantity of the power generation apparatus which is a prediction target at the time slot to be predicted after a predetermined time, on the basis of the peripheral variation pattern of the power generation apparatus.

Patent Document 4 discloses an electric power supply and demand control apparatus including a storage unit that stores a quantity of supply indicating a sum total of power supplied to consumers, a quantity of use indicating power used, by the consumers, reserve power indicating a range of power adjustable by the consumers, and a response record including a time taken for the consumer to reach a first adjustment quantity in the past, an inference unit that infers response characteristics including a response speed until arrival at a maximum of the reserve power on the basis of the response record, a first calculation unit that calculates a target value for eliminating a supply-demand unbalance between the quantity of supply and the quantity of demand which is given by a sum total of the quantities of use, and a second calculation unit that calculates a second adjustment quantity so chat a sum total of the second adjustment quantities comes close to the target value and that the second adjustment quantity is within a range of the reserve power restricted from the response characteristics.

Patent Document 5 discloses a system power management system in which, when the energy saving request to the consumers is created, a quantity of power supply which is notified by a smart meter of a consumer is normalized with a contracted use quantity of power, a threshold value for sorting out consumers who are targets for energy saving is determined on the basis of the normalized result, using a database and a statistical distribution of the normalized quantity of power supply for each consumer, and a consumer whose power supply exceeds the threshold value is notified of a request for energy saving, in a mesh area management server.

Patent Document 6 discloses a power supply service providing system in which a right to use a device is traded between a server belonging to an intensive consumer that supplies purchased power and controllers belonging to individual consumers so that cost benefits are obtained for the intensive consumer and the individual consumers therebetween, and the server controls devices on the individual consumer sides.

### RELATED DOCUMENTS

### Patent Documents

[Patent Document 1] Japanese Unexamined Patent Publication No. 2012-205385

[Patent Document 2] Japanese Unexamined Patent Publication No. 2012-210151

[Patent Document 3] Japanese Unexamined Patent Publication No. 2013-51326

[Patent Document 4] Japanese Unexamined Patent Publication No. 2013-9565

[Patent Document 5] Japanese Unexamined Patent Publication No. 2012-178935

[Patent Document 6] Japanese Unexamined Patent Publication No. 2010-140242

### SUMMARY OF THE INVENTION

### Technical Problem

Under tight electric power supply or the like, a consumer may be requested to reduce the power quantity purchased from a system (a request for a reduction in a power purchase quantity). For example, a time slot for which a request for a reduction in the power purchase quantity is made and a target reduction are set, and the request for a reduction in the power purchase quantity is made while an appropriate incentive to a predetermined consumer is provided in order to achieve the target quantity.

The request for a reduction in the power purchase quantity is made on the basis of an appropriate plan (for example, the determination of a consumer to whom the request for a reduction in the power purchase quantity is made, the expectation value of the reduction for each consumer, or the like), thereby allowing a reduction in the power quantity purchased from a system performed by a consumer to be advanced as planned. However, in a case where the plan is inappropriate, there may occur an inconvenience that the reduction in power purchase falls far short of a target quantity, or reversely, the reduction in power purchase greatly exceeds the target quantity and power is in excess. In cases of the techniques disclosed in Patent Documents 1 to 6, it is not possible to appropriately create a plain of the request for a reduction in the power purchase quantity.

An object of the present invention is to provide a technique for creating an appropriate plan of a request for a reduction in the power purchase quantity.

### Solution to Problem

According to the present invention, there is provided an electric power supply and demand control apparatus including: a remaining battery level acquisition unit that acquires remaining battery level information indicating a remaining battery level of a storage battery of a consumer; and a setting unit that sets an expectation value of a reduction in power purchased by the consumer from a system, on the basis of the remaining battery level information.

In addition, according to the present invention, there is provided a program for causing a computer to function as: a remaining battery level acquisition unit that acquires remaining battery level information indicating a remaining battery level of a storage battery of a consumer; and a setting unit that sets an expectation, value of a reduction in power purchased by the consumer from a system, on the basis of the remaining battery level information.

In addition, according to the present invention, there is provided an electric power supply and demand control method performed, by a computer, the method comprising: a remaining battery level acquisition step of acquiring remaining battery level information indicating a remaining battery level of a storage battery of a consumer; and a setting step of setting an expectation value of a reduction in power purchased by the consumer from a system, on the basis of the remaining battery level information.

### Advantageous Effects of Invention

According to the present invention, a technique for creating an appropriate plan of a request for a reduction in the power purchase quantity is realized.

### BRIEF DESCRIPTION OF THE DRAWINGS

The above and other objects, features and advantages will be made clearer from preferred exemplary embodiments described below, and the following accompanying drawings.

FIG. 1 is a diagram conceptually illustrating an example of a hardware configuration of an apparatus of the present exemplary embodiment.

FIG. 2 is a diagram schematically illustrating the entire image of a system to which an electric power supply and demand control apparatus 10 of the present exemplary embodiment is applied.

FIG. 3 is an example of a functional block diagram of the electric power supply and demand control apparatus 10 of the present exemplary embodiment.

FIG. 4 is a diagram schematically illustrating an example of registration information which is registered with the electric power supply and demand control apparatus 10 of the present exemplary embodiment.

FIG. 5 is a flow diagram illustrating an example of a flow of processes performed by the electric power supply and demand control apparatus 10 of the present exemplary embodiment.

FIG. 6 is a diagram schematically illustrating an example of information which is output by the electric power supply and demand control apparatus 10 of the present exemplary embodiment.

FIG. 7 is an example of a functional block diagram of the electric power supply and demand control apparatus 10 of the present exemplary embodiment.

FIG. 8 is an example of a functional block diagram of the electric power supply and demand control apparatus 10 of the present exemplary embodiment.

FIG. 9 is an example of a functional block diagram of the electric power supply and demand control apparatus 10 of the present exemplary embodiment.

FIG. 10 is a diagram schematically illustrating an example of consumption prediction information which is acquired by the electric power supply and demand control apparatus 10 of the present exemplary embodiment.

FIG. 11 is an example of a functional block diagram of the electric power supply and demand control apparatus 10 of the present exemplary embodiment.

### DESCRIPTION OF EXEMPLARY EMBODIMENTS

First, an example of a hardware configuration of an apparatus of the present exemplary embodiment will be described. Each unit included in the apparatus of the present exemplary embodiment is embodied by any combination of hardware and software based on a central processing unit (CPU), a memory, a program (also including a program downloaded from a recording medium such as a compact disc (CD), a server on the Internet, or the like, in addition to a program stored within a memory from a step of shipping an apparatus in advance) loaded into the memory, a storage unit such as a hard disc having the program stored thereon, and an interface for network connection of any computer. It will be understood by those skilled in the art that embodying methods and apparatuses thereof may be modified in various ways.

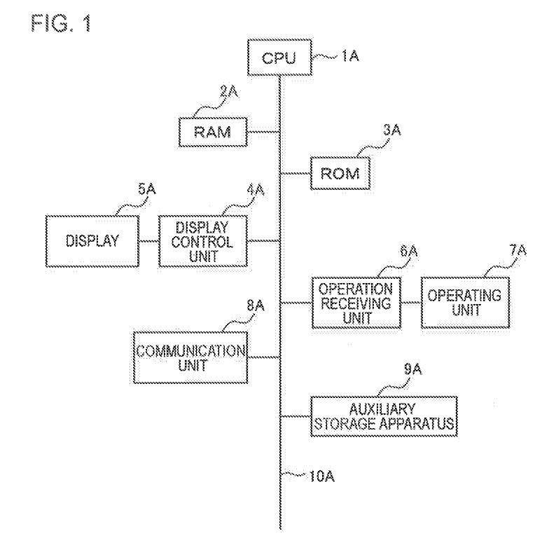

FIG. 1 is a diagram conceptually illustrating an example of a hardware configuration of the apparatus of the present exemplary embodiment. As shown in the drawing, the apparatus of the present exemplary embodiment includes, for example, a CPU 1A, a random access memory (RAM) 2A, a read only memory (ROM) 3A, a display control unit 4A, a display 5A, an operation receiving unit 6A, an operating unit 7A, a communication unit 8A, an auxiliary storage apparatus 9A, and the like which are connected to each other through a bus 10A. Note that although not shown in the drawing, the apparatus may include other elements such as an input and output interface connected to an external device in a wired manner, a microphone, and a speaker, in addition thereto.

The CPU 1A controls the entire computer of the apparatus together with each element. The ROM 3A includes an area for storing programs for bringing the computer into operation, various application programs. various setting data used when these programs operate, and the like. The RAM 2A includes an area, such as a work area in order for programs to operate, in which data is temporarily stored. The auxiliary storage apparatus 9A is, for example, a hard disc drive (HDD), and can store high-capacity data.

The display 5A is, for example, a display apparatus (such as a light emitting diode (LED) indicator, a liquid crystal display, or an organic electro luminescence (EL) display). The display 5A may be a touch panel display integrated with a touch pad. The display control unit 4A performs various screen displays by reading out data stored in a video RAM (VRAM), performing a predetermined process on the read-out data, and then sending the data to the display 5A. The operation receiving unit 6A receives various operations through the operating unit 7A. The operating unit 7A includes an operation key, an operation button, a switch, a jog dial, a touch panel display, a keyboard, and the like. The communication unit 8A is connected to a network such as the Internet or a local area network (LAN) in a wired and/or wireless manner, and communicates with other electronic devices.

Hereinafter, the exemplary embodiments will be described. Note that each functional block diagram which is used in the description of the following exemplary embodiments represents a function-based block rather than a hardware-based configuration. In the drawings, each apparatus is described to be embodied by one device, but its embodying means is not limited thereto. That is, the respective apparatuses may be physically separated from each other, and may be logically separated from each other. Note that the same components are denoted by the same reference numerals and signs, and thus the description thereof will not be repeated.

### First Exemplary Embodiment

First, the outline of the present exemplary embodiment will be described. In the present exemplary embodiment, when a plan of a request for a reduction in the power quantity purchased from a system is created, the remaining battery level of a storage battery of a consumer is grasped. An expectation value of the reduction in power purchase for each, consumer is determined on the basis of the grasped remaining battery level. The plan of a request for a reduction in the power purchase quantity can be created on the basis of the expectation value determined in this manner. For example, a plurality of consumers to whom the request for a reduction in the power purchase quantity is made are determined so that the total sum of the expectation values is approximate to a target quantity (total quantity) of reduction. In a case where a consumer achieves the expectation value in accordance with the request for a reduction in the power purchase quantity, a predetermined incentive may be offered to the consumer.

For example, in a case where the remaining battery level of a storage battery of a certain consumer is L (Wh), L×M (M is a real number greater than 0 and equal to or less than 1) or L×M+α may be determined as the expectation value for the consumer.

In a case where the expectation value is L×M, the expectation value of the reduction in power purchase for a consumer is set to be within a range of the remaining battery level of a storage battery. That is, the consumer can achieve the expectation value of the request for a reduction in the power purchase quantity while using an electrical device as usual without being imposed a limitation of turning-off or the like of the electrical device which is usually turned on, by using power of a storage battery instead of purchasing and using power from a system at a requested time slot. In this case, the consumer can easily achieve the expectation value. A predetermined, incentive can be received. Therefore, the number of consumers complying with the request for a reduction in the power purchase quantity is expected to increase.

Here, “+α” of L×M+α is an expectation value of a consumer's effort to turn off an electrical device which is usually used, or the like. That is, α (expectation value) is an expectation value of a reduction in power purchase from a power system by a consumer's effort to turn off an electrical device which is usually used, or the like, without using power with which a storage battery is charged. The higher the value of α is, the more a consumer needs to reduce the power purchase quantity by an effort on the consumer side such as turning-off of a device or the like. As a result, a burden on a consumer increases. For a consumer, it is preferable that the value of α (expectation value) is a small value. The smaller the burden on a consumer is, the more expected the number of consumers complying with the request for a reduction in the power purchase quantity is.

For example, a may be any value of equal to or less than 50% of L×M, preferably equal to or less than 25%, and more preferably equal to or less than 5%. In a case where α is set to such a small value, a consumer can relatively easily achieve the expectation value. A predetermined incentive can be received. Therefore, the number of consumers complying with the request for a reduction in the power purchase quantity is expected to increase.

As stated above, in a case of the present exemplary embodiment, the expectation value of the reduction in power purchase for a consumer can be set to a value easily achievable by each consumer, for each consumer, on the basis of the remaining battery level of a storage battery of each consumer. Therefore, the number of consumers complying with the request for a reduction in the power purchase quantity is expected to increase. As a result, a reduction in the power purchase quantity easily proceeds as planned.

Hereinafter, the configuration of the electric power supply and demand control apparatus of the present exemplary embodiment will be described.

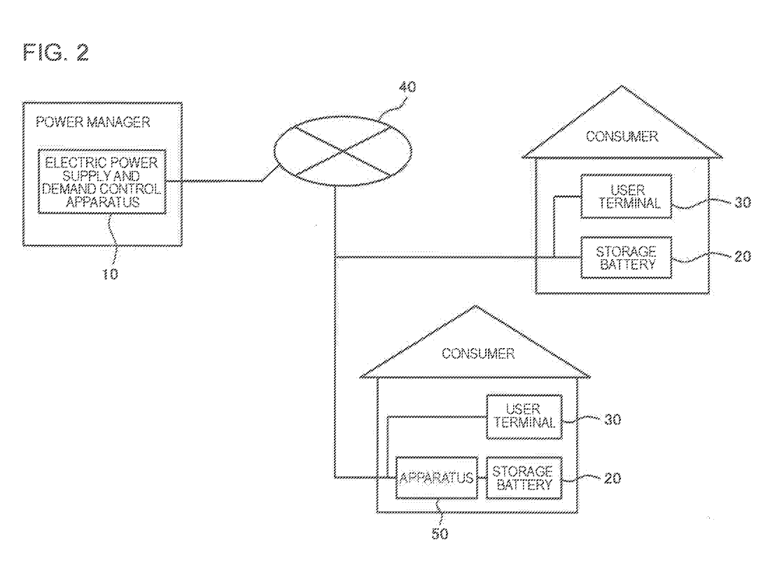

First, FIG. 2 schematically illustrates the entire image of a system to which an electric power supply and demand control apparatus 10 is applied. As shown in FIG. 2, an example of players relating to the system of the present exemplary embodiment includes a power manager that performs control (electric power supply and demand control) for taking a balance of power demand and supply, and consumers that use power. The power manager corresponds to, for example, a power company, an aggregator or the like. The consumer is a general household, an enterprise, a public facility or the like.

In the present exemplary embodiment, the power manager operates and manages the electric power supply and demand control apparatus 10. The consumer operates and manages a storage battery 20, a user terminal 30, and another apparatus 50 that controls these components. As shown in the drawing, these apparatuses are configured to be communicable with each other through a network 40.

The electric power supply and demand control apparatus 10 is placed under the management of a service provider that performs control of electric power supply and demand. The electric power supply and demand control apparatus 10 communicates with the storage battery 20, the user terminal 30, the apparatus 50 and the like through the network 40 such as the Internet or a LAN. In addition, the electric power supply and demand control apparatus 10 may acquire information indicating the remaining battery level of each storage battery from the storage battery 20 or the apparatus 50. In addition, the electric power supply and demand control apparatus 10 may transmit the request for a reduction in the power purchase quantity to each user terminal 30.

The storage battery 20 is placed under the management of each consumer. The storage battery 20 and the electric power supply and demand control apparatus 10 transmit and receive information through various means. For example, as shown in FIG. 2, the storage battery 20 may communicate directly with the electric power supply and demand control apparatus 10, and may communicate therewith through the apparatus 50. An example of the apparatus 50 includes, for example, a smart meter, a home energy management system (HEMS) or the like. Besides, in a case where there is an electricity storage cloud that accumulates information relating to the state (such as a remaining battery level) of the storage battery 20, a HEMS cloud that accumulates information (such as the remaining battery level of a storage battery) which is managed by the KEMS, or the like, the storage battery 20 and/or the HEMS may transmit the information to the cloud. The electric power supply and demand control apparatus 10 may acquire the information (such as the remaining battery level of a storage battery) from the cloud.

The apparatus 50 is placed under the management of each consumer. For example, the apparatus 50 communicates with the storage battery 20 of each consumer, and receives a notification of the remaining battery level of the storage battery 20. The apparatus 50 notifies the electric power supply and demand control apparatus 10 of the remaining battery level of the storage battery 20. Besides, the apparatus 50 receives information indicating the status of power consumption performed by each consumer or the status of power purchase from a system, from various sensors installed at predetermined positions. The apparatus 50 may transmit the information (for example, time-series data indicating the quantity of power consumption performed by a consumer, or time-series data indicating the power quantity purchased from a system) to the electric power supply and demand control apparatus 10.

The user terminal 30 is, for example, a cellular phone such as a smartphone, a personal computer (PC), or the like. Note that the electric power supply and demand control apparatus 10 may transmit the request for a reduction in the power purchase quantity to the apparatus 50, instead of transmitting the request to the user terminal 30.

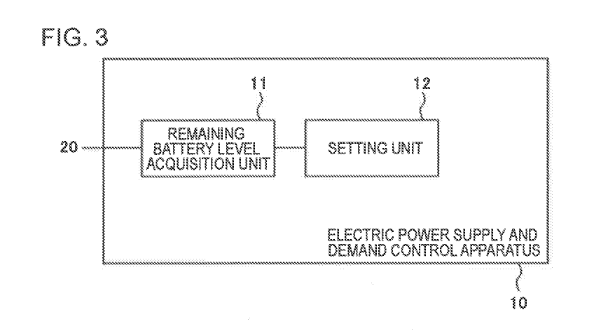

Next, the configuration of the electric power supply and demand control apparatus 10 will be described. FIG. 3 illustrates an example of a functional block diagram of the electric power supply and demand control apparatus 10. As shown in the drawing, the electric power supply and demand control apparatus 10 includes a remaining battery level acquisition unit 11 and a setting unit 12.

The remaining battery level acquisition unit 11 acquires remaining battery level information indicating the remaining battery level of the storage battery 20 of a consumer. For example, a consumer placed under the management of control of electric power supply and demand performed by the electric power supply and demand control apparatus 10 is registered in advance with the electric power supply and demand control apparatus 10. The remaining battery level acquisition unit 11 acquires the remaining battery level information relating to the storage battery 20 of the registered consumer at a predetermined timing (for example, timing at which there is an instruction input from an operator of a power manager such as a power company, an aggregator, or a new electric power enterprise shown in FIG. 2 which makes the request for a reduction in the power purchase quantity). Note that the predetermined timing is not limited to a timing at which there is an instruction input from a power manager as stated above. For example, the remaining battery level information of a storage battery may be periodically transmitted to the electric power supply and demand control apparatus of a power manager from the apparatus 50 of a consumer through a network.

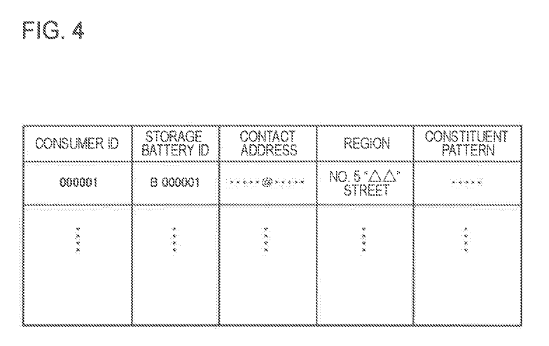

FIG. 4 illustrates an example of registration information. In the example shown in FIG. 4, identification information (consumer ID) of consumers, identification information (storage battery ID) of the storage battery 20 possessed by each consumer, a contact address (such as, for example, an e-mail address or a telephone number) of each consumer, region information for performing grouping into each neighboring area on the basis of the address of each consumer, and a constituent pattern indicating the constituent of each consumer are registered. Note that the region and the constituent pattern may not be included. In addition, other information may be registered with the registration information. For example, specification information including the maximum capacity, maximum output or the like of each storage battery 20, address information (address for communication through the network 40) of the apparatus 50, and the like may be included.

The constituent pattern indicates the constituent of a consumer, for example, the details of constituent members, and the like. The constituent pattern may be classified as, for example, a general household, a company (office), a store, a factory, or the like. The constituent pattern can be classified in more detail. For example, the general household may be classified in more detail by the number of family members, and the sex, occupation, age and the like of each member. For example, the general household may be classified like “20's university student (male): single residence”, “40's office-working father+40's non-working mother+teenage high-school student (female): three persons residence”, and the like.

In addition, the company may be classified in more detail by its scale. For example, the company may be classified as “equal to or less than 10 employees”, “more than 10 employees and equal to or less than 50”, or the like. In addition, the store may be classified in more detail by the type of store (for example, supermarket, convenience store, restaurant, and the like) or its scale (for example, the number of employees, site area, and the like). In addition, the factory may be classified in more detail by the type of factory (for example, automobile assembly factory, paint manufacturing factory, and the like) or its scale (for example, the number of employees, site area, and the like).

There are various means of causing the remaining battery level acquisition unit 11 to acquire the remaining battery level information. For example, the electric power supply and demand control apparatus 10 or other apparatuses may acquire the remaining battery level information of the storage battery 20 of the registered consumer periodically (for example, every five minutes, every fifteen minutes, every thirty minutes, or every one hour) from the storage battery 20, the apparatus 50 or the like, and manage an up-to-date state, for each consumer, as storage battery information for each consumer. The remaining battery level acquisition unit 11 may access the storage battery information for each consumer at a predetermined timing (for example, timing at which there is an instruction input from a user who creates the request for a reduction in the power purchase quantity), and acquire the remaining battery level information.

Besides, the remaining battery level acquisition unit 11 may acquire up-to-date remaining battery level information from the storage battery 20, the apparatus 50 or the like of the registered consumer at a predetermined timing (for example, timing at which there is an instruction input from a user who creates the request for a reduction in the power purchase quantity).

The remaining battery level information may indicate the quantity of power (Wh), and may indicate the state of charge (SOC). In a case where the remaining battery level acquisition unit 11 acquires the SOC as the remaining battery level information, for example, the model number, standard or the like of each storage battery 20 is registered with the electric power supply and demand control apparatus 10, as the registration information (not shown in FIG. 4), and the quantity of power (Wh) at full charge of each storage battery 20 can be grasped. The remaining battery level of power (Wh) of the storage battery 20 is calculated from the information (the quantity of power (Wh) at full charge) and the SOC.

Referring back to FIG. 3, the setting unit 12 sets the expectation value of the reduction in power purchase from the system, performed by the consumer, on the basis of the remaining battery level information acquired by the remaining battery level acquisition unit 11.

For example, in a case where the remaining battery level of a storage battery of a certain consumer is L (Wh), the setting unit 12 can set L×M (M is a real number greater than 0 and equal to or less than 1) as the expectation value of the consumer. Besides, the setting unit 12 may set L×M+α as the expectation value of the consumer. Here, “+α” is an expectation value of a consumer's effort such as turning off an electrical device which is usually used, or the like. It is preferable that this value is not excessively large. For example, α may be any value of equal to or less than 50% of L×M, preferably equal to or less than 25%, and more preferably equal to or less than 5%. Besides, a may be any value of equal to or less than 1,500 Wh, preferably equal to or less than 750 Wh, and more preferably equal to or less than 150 Wh.

M may be determined on the basis of a history for each consumer indicating whether to comply with the request for a reduction in the power purchase quantity so far, or the size of an incentive offered this time by the request for a reduction in the power purchase quantity. For example, as a consumer has a higher ratio in response to the request for a reduction in the power purchase quantity, M may be made larger. In addition, the larger the incentive is, the larger M may be.

The setting unit 12 can set the expectation value for each consumer on the basis of the remaining battery level information of each consumer. That is, the setting unit 12 can set different expectation values for each consumer.

Besides, the setting unit 12 may group a plurality of consumers, and set an expectation value for each group. In this case, the expectation values of consumers belonging to the same group are set to the same value.

For example, the setting unit 12 may set consumers of the same region, consumers of the same constituent pattern and region, or consumers of the same constituent pattern, as the same group, on the basis of the registration information (see FIG. 4). Besides, the setting unit 12 may group a plurality of consumers on the basis of the details of the storage battery 20 or the communication state of a terminal which is used by a consumer. Specifically, a plurality of consumers may be grouped in accordance with the remaining battery level of the storage battery 20. Alternatively, a plurality of consumers may be grouped in accordance with the response speed (speed between receiving a power output command and then starting a power output) of the storage battery 20. For example, when the registration information as shown in FIG. 4 is initially registered corresponding to a certain consumer, the response speed of the storage battery 20 of the consumer may be measured to be recorded in the registration information. Thereafter, the response speed may be measured at a predetermined timing (for example, every other year) to update the registration information. The setting unit 12 may perform grouping on the basis of the response speed written in the registration information. Besides, when the registration information as shown in FIG. 4 is initially registered, the communication speed of a predetermined terminal (any of the apparatus 50, the storage battery 20 and the user terminal 30) which is used by a consumer may be measured to be recorded in the registration information. Thereafter, the communication speed may be measured at a predetermined timing (for example, every other year) to update the registration information. The setting unit 12 may perform grouping on the basis of the communication speed written in the registration information.

After grouping, the setting unit 12 may determine a representative value of the remaining battery levels (Wh) of the storage batteries 20 for each group, and determine the expectation value on the basis of the determined remaining battery level (representative value). The representative value may be a statistical value (for example, average value, maximum, value, minimum value, most frequent value, intermediate value, or the like) of the remaining battery levels (Wh) of the storage batteries 20 of respective consumers belonging to a groups.

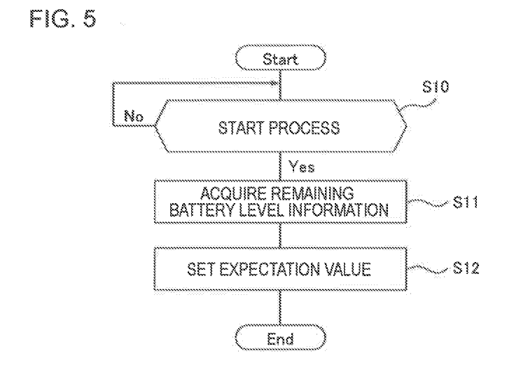

Next, the flow diagram of FIG. 5 illustrates an example of a flow of processes of the electric power supply and demand control apparatus 10 of the present exemplary embodiment.

The remaining battery level acquisition unit 11 is set to be in a standby state until there is an instruction input for setting the expectation value of a consumer (No in S10). In a case where there is an instruction input for setting the expectation value of a consumer (Yes in S10), the remaining battery level acquisition unit 11 acquires the remaining battery level information indicating the remaining battery level of the storage battery 20 of a consumer (S11).

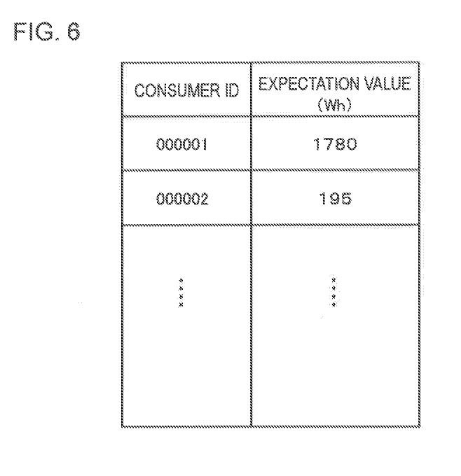

Then, the setting unit 12 sets the expectation value of the reduction in power purchase from the system performed by a consumer, for each consumer, on the basis of the remaining battery level information acquired in S11, and outputs a result (S12). FIG. 6 illustrates an example of output results of the setting unit 12. In the output results, a set expectation value is associated with each consumer. According to the electric power supply and demand control apparatus 10 of the present exemplary embodiment, such output results are obtained.

Thereafter, a user who creates a plan of the request for a reduction in the power purchase quantity may determine a consumer to whom the request for a reduction in the power purchase quantity is made on the basis of the expectation values (for example, FIG. 6) which are set by the setting unit 12. For example, a plurality of consumers to whom the request for a reduction in the power purchase quantity is made may be determined so that the total sum of the expectation values of the respective consumers are approximate to a target reduction (total quantity). The term “approximate” as used herein may be, for example, in a state where the total sum of the expectation values of the respective consumers exceeds the target reduction (total quantity) and the difference therebetween is equal to or less than a predetermined level.

The request for a reduction in the power purchase quantity which is made to a consumer determined in this manner is to give notice of, for example, a time slot for executing a reduction in the power purchase quantity, and the requested reduction (expectation value determined for each consumer). Further, the request for a reduction in the power purchase quantity may be a notice to offer a predetermined incentive in a case where the requested reduction is achieved at the time slot for executing a reduction in the power purchase quantity. Notice of the request for a reduction in the power purchase quantity may be given to a predetermined contact address by E-mail or the like, for example, on the basis of the registration information (see, for example, FIG. 4).

In the present exemplary embodiment, a method of determining an achievement of the requested reduction is not particularly limited, but the predicted quantity of power consumption of a consumer at a time slot for executing a reduction in the power purchase quantity may be calculated from the past performance or the like of each consumer, on the basis of, for example, the day's attribute (date, a day of the week, time slot, weather, or the like). In a case where the reduced quantity from this predicted quantity of power consumption satisfies the requested reduction, the requested reduction may be determined to be achieved.

In addition, similarly, a request for reduction is made to a consumer using “reducible margin of the quantity of power reduction” which is the expectation value of each consumer and is determined on the basis of the remaining battery level information of a storage battery from the past performance, and the requested reduction may be determined to be achieved in a case where the reduced quantity satisfies the requested reduction.

According to the electric power supply and demand control apparatus 10 of the present exemplary embodiment described above, the expectation value of the reduction in power purchase for a consumer can be set to a value easily achievable by each consumer, for each consumer, on the basis of the remaining battery level of the storage battery 20 of each consumer. Therefore, the number of consumers complying with the request for a reduction in the power purchase quantity is expected to increase. As a result, a reduction in the power purchase quantity easily proceeds as planned. That is, it is possible to reduce the occurrence of a disadvantage that the reduction in power purchase falls far short of a target quantity, or reversely, the reduction in power purchase greatly exceeds the target quantity and power is in excess.

### Second Exemplary Embodiment

The present exemplary embodiment is different from the first exemplary embodiment, in that the electric power supply and demand control apparatus 10 determines a consumer to whom a request for a reduction in the power purchase quantity is made. Hereinafter, points different from those in the first exemplary embodiment will be described in detail. Note that the description of the same points as those in the first exemplary embodiment will not be repeated.

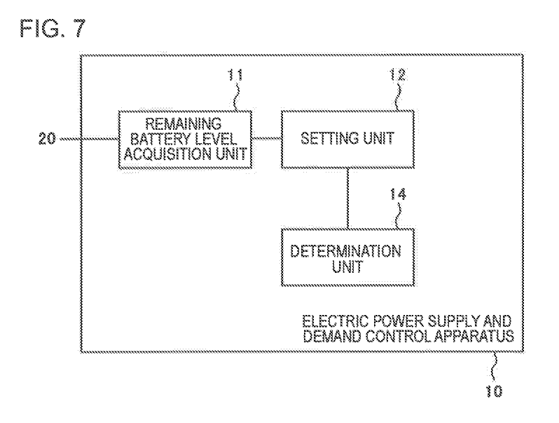

FIG. 7 illustrates an example of a functional block diagram of the electric power supply and demand control apparatus 10 of the present exemplary embodiment. As shown in the drawing, the electric power supply and demand control apparatus 10 includes the remaining battery level acquisition unit 11, the setting unit 12, and a determination unit 14. The configurations of the remaining battery level acquisition unit 11 and the setting unit 12 are the same as those in the first exemplary embodiment.

The determination unit 14 determines a power purchase quantity adjustment plan on the basis of the expectation value (for example, FIG. 6) which is set by the setting unit 12 for each consumer. Specifically, the determination unit 14 determines a consumer to whom the request for a reduction in the power quantity purchased from the system is made, on the basis of the expectation value (for example, FIG. 6) which is set by the setting unit 12 for each consumer.

The determination unit 14 may extract consumers whose storage battery 20 has the remaining battery level that is equal to or greater than a predetermined value, for example, on the basis of the remaining battery level information, and then determine a consumer to whom the request for a reduction in the power purchase quantity is made from the extracted consumers. With such a configuration, the request is made to the consumer whose storage battery 20 has a remaining battery level that is equal to or greater than the predetermined value, and thus there is a high probability of the consumer complying with the request.

A target reduction (total quantity) is input to the determination unit 14. The determination unit 14 may determine a plurality of consumers to whom the request for a reduction in the power purchase quantity is made so that the total sum of the expectation values of the respective consumers is approximate to the target reduction (total quantity). The term “approximate” as used herein may be, for example, in a state where the total sum of the expectation values of the respective consumers exceeds the target reduction (total quantity) and the difference therebetween is equal to or less than a predetermined level. That is, the determination unit 14 may determine a plurality of consumers to which the request for a reduction in the power purchase quantity is made so that the total sum of the expectation values of the respective consumers falls within a predetermined numerical range (which is, for example, equal to or greater than the (target reduction) and within the (target reduction)+α; α is any value) determined on the basis of the target reduction (total quantity).

According to the present exemplary embodiment, the same advantageous operations and effects as those in the first exemplary embodiment are realized. Further, according to the present exemplary embodiment, the electric power supply and demand control apparatus 10 can determine a consumer to whom the request for a reduction in the power purchase quantity is made. As a result, it is possible to reduce a burden of a user who creates a plan of the request for a reduction in the power purchase quantity.

### Third Exemplary Embodiment

The present exemplary embodiment is different from the first and second exemplary embodiments, in that the electric power supply and demand control apparatus 10 makes the request for a reduction in the power purchase quantity to a predetermined consumer in accordance with the determination results of the determination unit 14, and that a predetermined incentive is offered to a consumer complying with the request. Hereinafter, points different from those in the first and second exemplary embodiments will be described in detail. Note that the description, of the same points as those in the first and second exemplary embodiments will not be repeated.

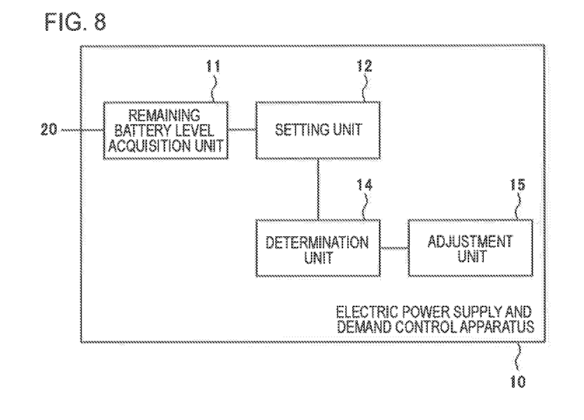

FIG. 8 illustrates an example of a functional block diagram of the electric power supply and demand control apparatus 10 of the present exemplary embodiment. As shown in the drawing, the electric power supply and demand control apparatus 10 includes the remaining battery level acquisition unit 11, the setting unit 12, the determination unit 14, and an adjustment unit 15. The configurations of the remaining battery level acquisition unit 11, the setting unit 12 and the determination unit 14 are the same as those in the first and second exemplary embodiments.

The adjustment unit 15 makes the request for a reduction in the power quantity purchased from the system to a consumer determined by the determination unit 14. In a case where the reduction reaches a predetermined value, the adjustment unit 15 offers a predetermined incentive to the consumer.

For example, the adjustment unit 15 notifies the consumer determined by the determination unit 14 of the request for a reduction in the power purchase quantity, by e-mail, on the basis of the registration information (see, for example, FIG. 4). The request for a reduction in the power purchase quantity may be to a notice of, for example, a time slot for executing a reduction in the power purchase quantity and an requested reduction (expectation value determined for each consumer), and further give notice of an offer of a predetermined incentive in a case where the requested reduction is achieved at the time slot.

A method of determining an achievement of the reduction is not particularly limited, but the predicted quantity of power consumption of a consumer at a time slot for executing a reduction in the power purchase quantity may be calculated from the past performance or the like of each consumer, on the basis of, for example, the day's attribute (date, a day of the week, time slot, weather, or the like). The requested reduction may be determined to be achieved in a case where the reduction (=(the predicted quantity of power consumption)−(the power purchase quantity)) from, the predicted quantity of power consumption satisfies the requested reduction, on the basis of information indicating the power purchase quantity of the consumer at the time slot for executing a reduction in the power purchase quantity, and the predicted quantity of power consumption, which are received from the apparatus 50 or the like of each consumer.

The details of the incentive and a method of offering the incentive can have every aspect adopted therein without being particularly limited.

According to the present exemplary embodiment described above, the same advantageous operations and effects as those in the first and second exemplary embodiments can be realized. In addition, according to the present exemplary embodiment, it is possible to offer a predetermined incentive to a consumer complying with the request for a reduction in the power purchase quantity. Therefore, the number of consumers complying with the request for a reduction in the power purchase quantity is expected to increase. As a result, a reduction in the power purchase quantity easily proceeds as planned.

### Fourth Exemplary Embodiment

In the present exemplary embodiment, power consumption for each time of each consumer at a time slot for which the request for a reduction in the power purchase quantity is made is predicted, and a plan of the request for a reduction in the power purchase quantity for each consumer is created on the basis of the prediction. Specifically, a time slot (for example, 11 o'clock to 15 o'clock, Jul. 25, 2014) for which the request for a reduction in the power purchase quantity is made is divided into a plurality of child time slots (for example, divided into eight child time slots in units of 30 minutes from 11 o'clock), and a consumer to whom the request for a reduction in the power purchase quantity is made and the expectation value of the reduction in power purchase are determined for each child time slot. The present exemplary embodiment is different from the first to third exemplary embodiments in the above point. Hereinafter, points different from those in the first to third exemplary embodiments will be described in detail. Note that the description of the same points as those in the first to third exemplary embodiments will not be repeated.

FIG. 3 illustrates an example of a functional block diagram of the electric power supply and demand control apparatus 10 of the present exemplary embodiment. As shown in the drawing, the electric power supply and demand control apparatus 10 includes the remaining battery level acquisition unit 11, the setting unit 12, a consumption prediction information acquisition unit 13, the determination unit 14, and the adjustment unit 15. Note that a configuration can also be used in which the adjustment unit 15 is not included therein. The configurations of the remaining battery level acquisition unit 11, the setting unit 12 and the adjustment unit 15 are the same as those in the first to third exemplary embodiments.

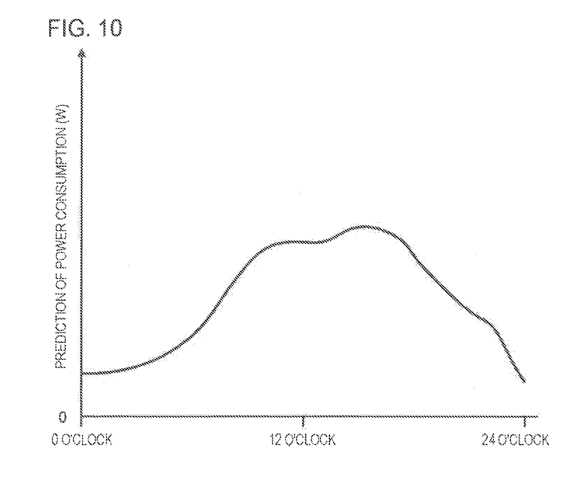

The consumption prediction, information acquisition unit 13 acquires consumption prediction information indicating the prediction of power consumption for each time performed by a consumer. The consumption prediction information includes at least the prediction of power consumption for each time of each consumer at a time slot for which the request for a reduction in the power purchase quantity is made. FIG. 10 schematically illustrates an example the consumption prediction information. The consumption prediction information indicates a prediction of power consumption for each time in a specific day (all day).

A method of making a prediction of power consumption for each time performed by a consumer can have every aspect adopted therein without being particularly limited. For example, on the basis of the day's attribute (such as the date, the day of the week, the time slot, or the weather), the prediction of power consumption for each time may be performed from the past performance or she like of each consumer. For example, the performance of a past day having the attribute approximate to the day's attribute at a predetermined level or higher may be set to the prediction of power consumption. Alternatively, on the basis of machine learning using past data in which an attribute and an performance of a day's power consumption for each time are associated with each other, the day's prediction of power consumption for each time may be performed from the attribute of the day when the prediction of power consumption is performed. The pass performance for each consumer may be acquired by the electric power supply and demand control apparatus 10, for example, from the apparatus 50 of each consumer, the HEMS cloud described in the first exemplary embodiment, or the like.

The consumption prediction information acquisition unit 13 may acquire the consumption prediction information for each consumer. Besides, the consumption prediction information acquisition unit 13 may group a plurality of consumers, and acquire the consumption prediction information for each group. In this case, pieces of the consumption prediction information of consumers belonging to the same group are set to be the same as each other.

The consumption prediction information acquisition unit 13 may group a plurality of consumers using the same method as grouping performed by the setting unit 12 which is described in the first exemplary embodiment. For example, the consumption prediction information acquisition unit 13 may set consumers of the same region, consumers of the same constituent pattern and region, or consumers of the same constituent pattern, as the same group, on the basis of the registration information (see FIG. 4). The consumption prediction information acquisition unit 13 may set a predetermined number of representatives for each group, and determine the consumption prediction information of each group on the basis of the consumption prediction information of the representatives. In a case where the number of representatives is one, the consumption prediction information of the representative may be set to consumption prediction information of the group. On the other hand, in a case where the number of representatives is two or more, for example, the average of pieces of the consumption prediction information of a plurality of representatives may be set to the consumption prediction information of the group.

In a case of consumers of the same constituent pattern or region, there is a high possibility of their life patterns being similar to each other. Therefore, it is considered that the tendencies of the prediction of power consumption for each time are often similar to each other, to the degree of being equally handled.

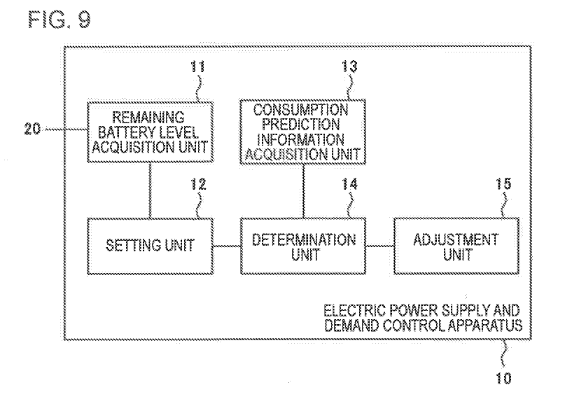

Referred back to FIG. 9, the determination unit 14 determines a power purchase quantity adjustment plan on the basis of the expectation value which is set by the setting unit 12 and the consumption prediction information which is acquired by the consumption prediction information acquisition unit 13. That is, the determination unit 14 determines a consumer to whom the request for a reduction in the power purchase quantity is made, a time slot for which the request for a reduction in the power purchase quantity is made to each consumer, and the expectation value of the reduction in power purchase for each time slot.

For example, the determination unit 14 divides the time slot (for example, 11 o'clock to 15 o'clock, Jul. 25, 2014) for which the request for a reduction in the power purchase quantity is made into a plurality of child time slots (for example, eight time slots obtained by division in units of 30 minutes from 11 o'clock). The determination unit 14 can determine a consumer to which the request for a reduction in the power purchase quantity is made, and the expectation value of the reduction in power purchase, for each child time slot.

An example of processes performed by the determination unit 14 will be described. Initially, a time slot (for example, 11 o'clock to 15 o'clock, Jul. 25, 2014) for which the request for a reduction in the power purchase quantity is made, and a target reduction (total quantity) to be reduced at the time slot are input to the determination unit 14. The determination unit 14 divides the time slot into a plurality of child time slots in accordance with a predetermined rule, and determines a target reduction for each child time slot. For example, the target reduction of each child time may be determined so that the total sum of target quantities of reduction for each child time slot is approximate to the target reduction (total quantity) of the time slot for which the request for a reduction in the power purchase quantity is made. The term “approximate” as used herein may be, for example, in a state where the total sum of the target quantities of reduction for each child time slot exceeds the target reduction (total quantity) of the time slot for which the request for a reduction in the power purchase quantity is made and the difference therebetween is equal to or less than a predetermined level. That is, the determination unit 14 may determine the target reduction of each child time so that the total sum of the target quantities of reduction for each child time slot falls within a predetermined numerical range (which is, for example, equal to or greater than, the (target reduction) and within the (target reduction)+α; α is any value) determined on the basis of the target reduction (total quantity) of the time slot for which the request for a reduction in the power purchase quantity is made. For example, the determination unit 14 may equally divide the target reduction (total quantity) into a plurality of child time slots.

Thereafter, the determination unit 14 determines a consumer to whom the request for a reduction in the power purchase quantity is made, and the expectation value of the reduction in power purchase, for each child time slot. Note that the determination unit 14 makes the determination so as to satisfy the following (1) and (2), for each consumer.

(1) The expectation value of the reduction in power purchase of each consumer at each child time slot is equal to or less than the prediction of power consumption quantity of each consumer at each child time slot.

(2) The total sum of the expectation values of the reduction in power purchase of each consumer at each child time slot is equal to or less than the expectation value of each, consumer which is set by the setting unit 12.

Originally, the poser purchase quantity is reducible only at a time slot (child time slot) when power is consumed. In addition, even in a case where a reduction in the power purchase quantity exceeding the quantity of power consumed is requested, it is not possible to comply therewith. In a case where such an inappropriate plan is created, the number of consumers complying with the request for a reduction in the power purchase quantity decreases.

In a case of the present exemplary embodiment, it is possible to create a plan to request the reduction equal to or less than the predicted quantity of power consumption at a time slot (child time slot) for which the request for a reduction in the power purchase quantity is made, with respect to a consumer predicted to consume power at the time slot (child time slot). Therefore, it is expected that the number of consumers complying with the request for a reduction in the power purchase quantity increases.

It should be noted that, with respect to a first consumer and a second consumer, the determination unit 14 may determine a power purchase quantity adjustment plan in which at least the child time slots for which the request for a reduction in the power purchase quantity is made or the expectation values of the reduction in power purchase for each child time slot are different from each other.

For example, with respect to the first consumer and the second consumer whose storage batteries 20 have different remaining battery levels, the determination unit 14 may determine a power purchase quantity adjustment plan in which the expectation values of the reduction in power purchase (for each child time slot) are different from each other. In addition, the determination unit 14 may determine a power purchase quantity adjustment plan in which time slots when the first consumer and the second consumer having different consumption prediction information are requested to reduce the power purchase quantity are different from each other.

In this manner, the degree of freedom of the power purchase quantity adjustment plan increases. A time slot (for example, 11 o'clock to 15 o'clock, Jul. 25, 2014) for which the request for a reduction in the power purchase quantity is made is divided into a plurality of child time slots, and an appropriate plan is created for each child time slot, thereby allowing the quantities of a reduction in power purchase performed by consumers to be distributed approximately equally within the time slot. That is, it is possible to reduce a disadvantage that a reduction in the power purchase quantity concentrates at a certain time slot, power is in excess within a system at the time slot, or the like.

Here, an example of processes performed by the determination unit 14 will be described. For example, it is assumed that “11 o'clock to 15 o'clock, Jul. 25, 2014” is input as a time slot for which the request for a reduction in the power purchase quantity is made. The determination unit 14 may divide the time slot into, for example, two child time slots of “11 o'clock to 13 o'clock, Jul. 25, 2014” and “13 o'clock to 15 o'clock, Jul. 25, 2014”, in accordance with a predetermined rule. Therereafter, the determination unit 14 determines a consumer to whom the request for a reduction in the power purchase quantity is made at each child time, and the expectation value of the reduction in power purchase. For example, the determination unit determines at which child time slot the prediction of power consumption is high for each consumer, and makes a determination so that the request for a reduction in the power purchase quantity is made for a predetermined number of child time slots in order from the highest prediction of power consumption. For example, a determination is made so that a consumer in which the prediction of power consumption is higher at “11 o'clock to 13 o'clock, Jul. 25, 2014” rather than “13 o'clock to 15 o'clock, Jul. 25, 2014” is requested to reduce the power purchase quantity at “11 o'clock to 13 o'clock, Jul. 25, 2014”, and that a consumer in which the prediction of power consumption is higher at “13 o'clock to 15 o'clock, Jul. 25, 2014” rather than “11 o'clock to 13 o'clock, Jul. 25, 2014” is requested to reduce the power purchase quantity at. “13 o'clock to 15 o'clock, Jul. 25, 2014”.

Thereafter, the setting unit 12 may set the expectation value of each consumer at each child time slot on the basis of the remaining battery level of the storage battery 20. A process of setting an expectation value on the basis of the remaining battery level of the storage battery 20 has been described, and thus the description thereof will not be repeated. Note that the determination unit 14 may initially extract consumers whose storage battery 20 has the remaining battery level that is equal to or greater than a predetermined value, and then determine a consumer to whom the request for a reduction in the power purchase quantity is made for each child time slot from the extracted consumers, on the basis of the prediction of power consumption of each extracted consumer. With such a configuration, it is possible to reduce the number of consumers which are candidates to whom the request for a reduction in the power purchase quantity is made for each child time slot on the basis of the prediction of power consumption. As a result, it is possible to reduce a processing burden.

Note that the time width of the request for a reduction in the power purchase quantity for each consumer may also be changed in accordance with the remaining battery level of a storage battery. For example, the determination unit 14 may determine a power purchase quantity adjustment plan in which time widths when the first consumer and the second consumer whose storage batteries 20 have different remaining battery levels are requested to reduce the power purchase quantity are different from each other.

For example, it is assumed that “11 o'clock to 15 o'clock, Jul. 25, 2014” is input as a time slot for which the request for a reduction in the power purchase quantity is made. In this case, the determination unit 14 divides the time slot into, for example, four child time slots of “11 o'clock to 12 o'clock, Jul. 25, 2014”, “12 o'clock to 13 o'clock, Jul. 25, 2014”, “13 o'clock to 14 o'clock, Jul. 25, 2014”, and “14 o'clock to 15 o'clock, Jul. 25, 2014”, in accordance with a predetermined rule. A determination may be made so that a consumer whose storage battery has the remaining battery level that is equal to or greater than a predetermined value is requested to reduce the power purchase quantity at three child time slots (for example, “11 o'clock to 12 o'clock, Jul. 25, 2014”, “12 o'clock to 13 o'clock, Jul. 25, 2014”, and “13 o'clock to 14 o'clock, Jul. 25, 2014”), and that a consumer whose storage battery has the remaining battery level that is less than the predetermined value is requested to reduce the power purchase quantity at one child time slot (for example, “12 o'clock to 13 o'clock, Jul. 25, 2014”).

In addition, the expectation values of the reduction in power purchase for consumers may be the same as each other, and may be different from each other for each consumer. For example, a determination may be made so that the larger remaining battery level of a storage battery a consumer has, the higher the expectation value is. In addition, a determination may be made so that the larger prediction of power consumption a consumer has, the higher the expectation value is.

According to the present exemplary embodiment described above, the same advantageous operations and effects as those in the first, to third exemplary embodiments can be realized. In addition, a time slot (child time slot) when each consumer is requested to reduce the power purchase quantity, and the expectation value thereof can be appropriately set (so as to be realizable by a consumer) on the basis of the prediction of power consumption for each time of each consumer. Therefore, the number of consumers complying with the request for a reduction in the power purchase quantity is expected to increase. As a result, a reduction in the power purchase quantity easily proceeds as planned.

### Fifth Exemplary Embodiment

In the present exemplary embodiment, incentive correspondence information indicating a change in the reduction in power purchase according to the details of an offered incentive is acquired for each consumer, and a plan of the request for a reduction in the power purchase quantity for each consumer is created on the basis of the incentive correspondence information. The present exemplary embodiment is different from the first to fourth exemplary embodiments in the above point. Hereinafter, points different from those in the first to fourth exemplary embodiments will be described in detail. Note that the description of the same points as those in the first to fourth exemplary embodiments will not be repeated.

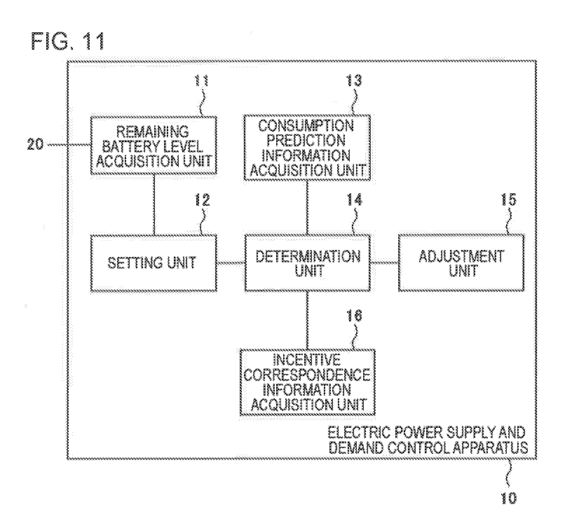

FIG. 11 illustrates an example of a functional block diagram of the electric power supply and demand control apparatus 10 of the present exemplary embodiment. As shown in the drawing, the electric power supply and demand control apparatus 10 includes the remaining battery level acquisition unit 11, the setting unit 12, the consumption prediction information acquisition unit 13, the determination unit 14, the adjustment unit 15, and an incentive correspondence information acquisition unit 16. Note that a configuration may also be used in which at least one of the consumption prediction information acquisition unit 13 and the adjustment unit 15 are not included therein. The configurations of the remaining battery level acquisition unit 11, the setting unit 12, the consumption prediction information acquisition unit 13 and the adjustment unit 15 are the same as those in the first to fourth exemplary embodiments.

The incentive correspondence information acquisition unit 16 acquires the incentive correspondence information indicating a change in the reduction in power purchase according to the details of the offered incentive, for each consumer. The incentive correspondence information may indicate, for example, a time slot having a high possibility of the reduction in power purchase being increased in accordance with the request for a reduction in the power purchase quantity, and the details of the incentive. For example, a time slot having a high possibility of the reduction in power purchase being increased in accordance with the request for a reduction in the power purchase quantity, and the details of the incentive may be specified, for each consumer on the basis of the past performance.

The determination unit 14 determines a power purchase quantity adjustment plan on the basis of the incentive correspondence information acquired by the incentive correspondence information acquisition unit 16. Specifically, the determination unit 14 may determine a time slot having a high possibility of the reduction in power purchase being increased in accordance with the request for a reduction in the power purchase quantity, for each consumer, on the basis of the incentive correspondence information, and make a determination so as to make the request for a reduction in the power purchase quantity for the time slot. The determination unit 14 may further determine the details of the incentive of each consumer to be details which is determined in the incentive correspondence information, and notify the adjustment unit 15 of the determined details.

According to the present exemplary embodiment described above, the same advantageous operations and effects as those in the first to fourth exemplary embodiments can be realized. In addition, time slot when each consumer is requested to reduce the power purchase quantity, and the details of the incentive can be set on the basis of the incentive correspondence information indicating a time slot having a high possibility of the reduction in power purchase being increased in accordance with the request for a reduction in the power purchase quantity, and the details of the incentive. Therefore, an increase in consumers complying with the request for a reduction in the power purchase quantity is expected. As a result, a reduction in the power purchase quantity easily proceeds as planned.

Hereinafter, examples of reference forms are appended

1. An electric power supply and demand control apparatus including:

a remaining battery level acquisition unit that acquires remaining battery level information indicating a remaining battery level of a storage battery of a consumer; and

a setting unit that sets an expectation value of a reduction in power purchased by the consumer from a system, on the basis of the remaining battery level information.

2. The electric power supply and demand control apparatus according to 1, wherein the setting unit that sets the expectation value for each consumer on the basis of the remaining battery level information of each consumer.

3. The electric power supply and demand control apparatus according to 1 or 2, further including a determination unit that determines a power purchase quantity adjustment plan in which the consumer to whom a request for a reduction in a power quantity purchased from a system is made is determined, on the basis of the expectation value which is set by the setting unit.

4. The electric power supply and demand control apparatus according to 3, wherein the determination unit extracts the consumer whose storage battery has a remaining battery level that is equal to or greater than a predetermined value on the basis of the remaining battery level information., and determines the consumer to whom the request is made from the extracted consumer.

5. The electric power supply and demand control apparatus according to 3 or 4, wherein the determination unit determines the power purchase quantity adjustment plan in which consumers to whom requests are made are determined so that a total sum of the expectation values of the consumers falls within a predetermined numerical range.

6. The electric power supply and demand control apparatus according to any one of 1 to 5, further including an adjustment unit that, requests the consumer to reduce a power quantity purchased from a system, and offers a predetermined incentive to the consumer in a case where a reduction reaches a predetermined value.

7. The electric power supply and demand control apparatus according to any one of 1 to 6, further including:

a consumption prediction information acquisition unit that acquires consumption prediction information indicating a prediction of power consumed by the consumer for each time; and

a determination unit that determines the consumer to whom the request for a reduction in a power quantity purchased from a system, on the basis of the expectation value which is set by the setting unit and the consumption prediction information.

8. The electric power supply and demand control apparatus according to 7, wherein the determination unit determines a power purchase quantity adjustment plan including a time slot at which the request for a reduction in a power purchase quantity is made to the determined consumer, and an expectation value of a reduction in power purchase for each of time slots.

9. The electric power supply and demand control apparatus according to 8, wherein the determination unit determines the power purchase quantity adjustment plan in which the expectation value of a reduction in power purchase of the consumer at each time slot is equal to or less than a prediction of power consumption quantity of the consumer at each time slot.

10. The electric power supply and demand control apparatus according to 8 or 9, wherein the determination unit determines the power purchase quantity adjustment plan in which a total sum of the expectation values of the reduction in power purchase of the consumer at each time slot is equal to or less than the expectation value of the consumer which is set by the setting unit.

11. The electric power supply and demand control apparatus according to any one of 8 to 10, wherein with respect to a first consumer and a second consumer whose storage batteries have different remaining battery levels, the determination unit determines the power purchase quantity adjustment plan in which the expectation values of the reduction in power purchase are different from each other.

12. The electric power supply and demand control apparatus according to any one of 8 to 11, wherein the determination unit determines the power purchase quantity adjustment plan in which time widths when the request for a reduction in a power purchase quantity is made to the first consumer and the second whose storage batteries have different remaining battery levels are different from each other.

13. The electric power supply and demand control, apparatus according to any one of 8 to 12, wherein the determination unit determines the power purchase quantity adjustment plan in which time slots when the request for a reduction in a power purchase quantity is made to the first consumer and the second, consumer having different consumption prediction information are different from each other.

14. The electric power supply and demand control apparatus according to any one of 8 to 13, further including an incentive correspondence information acquisition unit that acquires incentive correspondence information indicating a change in a reduction in power purchase according to details of an offered incentive, for each consumer, wherein the determination unit further determines the power purchase quantity adjustment plan on the basis of the incentive correspondence information.

15. The electric power supply and demand control apparatus according to any one of 7 to 14, wherein the consumption prediction information acquisition unit groups a plurality of consumers, and acquires the consumption prediction information for each group.

16. The electric power supply and demand control apparatus according to any one of 1 to 15, wherein the setting unit further sets the expectation value on the basis of a history for each consumer indicating whether to comply with a request for a reduction in a power purchase quantity, a size of an incentive which is offered to the consumer when complying with the request for a reduction in a power purchase quantity, or a prediction of power consumption for each consumer at a time slot for which the request for a reduction in a power purchase quantity is made.

17. The electric power supply and demand control apparatus according to 16, wherein the larger a rate of complying with a request for a reduction in a power purchase quantity, the incentive, the remaining battery level of a storage battery, or the prediction of power consumption is, the larger expectation value the setting unit sets.

18. The electric power supply and demand control apparatus according to any one of 1 to 17, wherein the setting unit groups a plurality of the consumers, and sets the expectation value for each, group.

19. The electric power supply and demand control apparatus according to 18, wherein the setting unit groups the plurality of the consumers on the basis of registration information indicating details of each consumer, details of the storage battery, or a communication state of a terminal used by the consumer.

20. A program for causing a computer to function as:

a remaining battery level acquisition unit that acquires remaining battery level information indicating a remaining battery level of a storage battery of a consumer; and

a setting unit that sets an expectation value of a reduction in power purchased by the consumer from a system, on the basis of the remaining battery level information.

20-2. The program according to 20, causing the setting unit to set the expectation value for each consumer on the basis of the remaining battery level information of each consumer.

20-3. The program according to 20 or 20-2, causing the computer to function as a determination unit that determines a power purchase quantity adjustment plan in which the consumer to whom a request for a reduction in a power quantity purchased from a system is made is determined, on the basis of the expectation value which is set by the setting unit.

20-4. The program according to 20-3, causing the determination unit to extract, the consumer whose storage battery has a remaining battery level that is equal to or greater than a predetermined value on the basis of the remaining battery level information, and to determine the consumer to whom the request is made from the extracted consumer.

20-5. The program according to 20-3 or 20-4, causing the determination unit to determine the power purchase quantity adjustment plan in which consumers to whom requests are made are determined so that a total sum of the expectation values of the consumers falls within a predetermined numerical range.

20-6. The program according to any one of 20 to 20-5, causing the computer to further function as an adjustment unit that requests the consumer to reduce a power quantity purchased from a system, and offers a predetermined incentive to the consumer in a case where a reduction reaches a predetermined value.

20-7. The program according to any one of 20 to 20-6, causing the computer to further function as:

a consumption prediction information acquisition unit that acquires consumption prediction information indicating a prediction of power consumed by the consumer for each time; and

a determination unit that determines the consumer to whom a request for a reduction in a power quantity purchased from a system is made, on the basis of the expectation value which is set by the setting unit and the consumption prediction information.

20-8. The program according to 20-7, causing the determination unit to determine a power purchase quantity adjustment plan including a time slot at which the request for a reduction in a power purchase quantity is made to the determined consumer, and an expectation value of a reduction in power purchase for each of time slots.

20-9. The program according to 20-8, causing the determination unit to determine the power purchase quantity adjustment plan in which the expectation value of a reduction in power purchase of the consumer at each time slot is equal to or less than a prediction of power consumption quantity of the consumer at each time slot.

20-10. The program according to 20-8 or 20-9, causing the determination unit to determine the power purchase quantity adjustment plan in which a total sum of the expectation values of the reduction in power purchase of the consumer at each time slot is equal to or less than the expectation value of the consumer which is set by the setting unit.

20-11. The program according to any one of 20-8 to 20-10, causing the determination unit to determine, with respect to a first consumer and a second consumer whose storage batteries have different remaining battery levels, the power purchase quantity adjustment plan in which the expectation values of the reduction in power purchase are different from each other.

20-12. The program according to any one of 20-8 to 20-11, causing the determination unit to determine the power purchase quantity adjustment plan in which time widths when the request for a reduction in a power purchase quantity is made to the first consumer and the second whose storage batteries have different remaining battery levels are different from each other.

20-13. The program according to any one of 20-8 to 20-12, causing the determination unit to determine the power purchase quantity adjustment plan in which time slots when the request for a reduction in a power purchase quantity is made to the first consumer and the second consumer having different consumption prediction information are different from each other.

20-14. The program according to any one of 20-8 to 20-13, causing the computer to further function as an incentive correspondence information acquisition unit that acquires incentive correspondence information indicating a change in a reduction in power purchase according to details of an offered incentive, for each consumer, and causing the determination unit to further determine the power purchase quantity adjustment plan on the basis of the incentive correspondence information.

20-15. The program according to any one of 20-7 to 20-14, causing the consumption prediction information acquisition unit to group a plurality of consumers, and to acquire the consumption prediction information for each group.

20-16. The program according to any one of 20 to 20-15, causing the setting unit to further set the expectation value on the basis of a history for each consumer indicating whether to comply with a request for a reduction in a power purchase quantity, a size of an incentive which is offered to the consumer when complying with the request for a reduction in a power purchase quantity, or a prediction of power consumption, for each consumer at a time slot for which the request for a reduction in a power purchase quantity is made.

20-17. The program according to 20-16, causing the setting unit to set the expectation value which is higher as a rate of complying with a request for a reduction in a power purchase quantity, the incentive, the remaining battery level of a storage battery, or the prediction of power consumption increases.

20-18. The program according to any one of 20 to 20-17, causing the setting unit to group a plurality of the consumers, and to set the expectation value for each group.

20-19. The program according to 20-18, causing the setting unit to group the plurality of the consumers on the basis of registration information indicating details of each consumer, details of the storage battery, or a communication state of a terminal used by the consumer.

21. An electric power supply and demand control method executed by a computer, the method including:

a remaining battery level acquisition step of acquiring remaining battery level information indicating a remaining battery level of a storage battery of a consumer; and

a setting step of setting an expectation value of a reduction in power purchase from a system performed by the consumer, on the basis of the remaining battery level information.

21-2. The electric power supply and demand control method according to 21, wherein the setting step includes setting the expectation value for each consumer on the basis of the remaining battery level information of each consumer.

21-3. The electric power supply and demand control method executed by the computer according to 21 or 21-2, the method further including a determination step of determining a power purchase quantity adjustment plan in which the consumer to whom a request for a reduction in a power quantity purchased from a system is made is determined, on the basis of the expectation value which is set in the setting step.

21-4. The electric power supply and demand control method according to 21-3, wherein the determination step includes extracting the consumer whose storage battery has a remaining battery level that is equal to or greater than a predetermined value on the basis of the remaining battery level information, and determines the consumer to whom the request is made from the extracted consumer.

21-5. The electric power supply and demand control method according to 21-3 or 21-4, wherein the determination step includes determining the power purchase quantity adjustment plan in which consumers to whom requests are made are determined so that a total sum of the expectation values of the consumers falls within a predetermined numerical range.

21-6. The electric power supply and demand control method executed by the computer according to any one of 21 to 21-5, the method further including an adjustment step of requesting the consumer to reduce a power quantity purchased from a system, and offering a predetermined incentive to the consumer in a case where a reduction reaches a predetermined value.

21-7. The electric power supply and demand control method executed by the computer according to anyone of 21 to 21-6, the method further including:

a consumption prediction information acquisition step of acquiring consumption prediction information indicating a prediction of power consumed by the consumer for each time; and

a determination step of determining the consumer to whom the request for a reduction in a power quantity purchased from a system, on the basis of the expectation value which is set by the setting unit and the consumption prediction information.

21-8. The electric power supply and demand control method according to 21-7, wherein the determination step includes determining a power purchase quantity adjustment plan including a time slot at which the request for a reduction in a power purchase quantity is made to the determined consumer, and an expectation value of a reduction in power purchase for each of time slots.

21-9. The electric power supply and demand control method according to 21-8, wherein the determination step includes determining the power purchase quantity adjustment plan in which the expectation value of a reduction in power purchase of the consumer at each time slot is equal to or less than a prediction of power consumption quantity of the consumer at each time slot.

21-10. The electric power supply and demand control method according to 21-8 or 21-9, wherein the determination step includes determining the power purchase quantity adjustment plan in which a total sum of the expectation values of the reduction in power purchase of the consumer at each time slot is equal to or less than the expectation value of the consumer which is set by the setting unit.

21-11. The electric power supply and demand control method according to any one of 21-8 to 21-10, wherein with, respect to a first consumer and a second consumer whose storage batteries have different remaining battery levels, the determination step includes determining the power purchase quantity adjustment plan in which the expectation values of the reduction in power purchase are different from each other.

21-12. The electric power supply and demand control method according to any one of 21-8 to 21-11, wherein the determination step includes determining the power purchase quantity adjustment plan in which time widths when the request for a reduction in a power purchase quantity is made to the first consumer and the second consumer whose storage batteries have different remaining battery levels are different from each other.

21-13. The electric power supply and demand control method according to any one of 21-8 to 21-12, wherein the determination step includes determining the power purchase quantity adjustment plan in which time slots when the request for a reduction in a power purchase quantity is made to the first consumer and the second consumer having different consumption prediction information are different from each other.

21-14. The electric power supply and demand control method according to any one of 21-8 to 21-13, causing the computer to further execute an incentive correspondence information acquisition step of acquiring incentive correspondence information indicating a change in a reduction in power purchase according to details of an offered incentive, for each consumer, wherein the determination step further includes determining the power purchase quantity adjustment, plan, on the basis of the incentive correspondence information.

21-15. The electric power supply and demand control method according to any one of 21-7 to 21-14, wherein the consumption prediction information acquisition step includes grouping a plurality of consumers, and acquiring the consumption prediction information for each group.

21-16. The electric power supply and demand control method according to any one of 21 to 21-15, wherein the setting step further includes setting the expectation value on the basis of a history for each consumer indicating whether to comply with a request for a reduction in a power purchase quantity, a size of an incentive which is offered to the consumer when complying with the request for a reduction in a power purchase quantity, or a prediction of power consumption for each consumer at a time slot for which the request for a reduction in a power purchase quantity is made.

21-17. The electric power supply and demand control method, according to 21-16, wherein in the setting step, the larger a rate of complying with a request for a reduction in a power purchase quantity, the incentive, the remaining battery level of a storage battery, or the prediction of power consumption is, the larger expectation, value the setting unit sets.

21-18. The electric power supply and demand control method according to any one of 21 to 21-17, wherein the setting step includes grouping a plurality of the consumers, and setting the expectation value for each group.

21-19. The electric power supply and demand control method according to 21-18, wherein the setting step includes grouping the plurality of the consumers on the basis of registration, information indicating details of each consumer, details of the storage battery, or a communication state of a terminal used by the consumer.

This application claims priority from Japanese Patent Application No. 2014-227822 filed on Nov. 10, 2014, the content of which is incorporated herein by reference in its entirety.

1. An electric power supply and demand control apparatus comprising:
a remaining battery level acquisition unit that acquires remaining battery level information indicating a remaining battery level of a storage battery of a consumer; and
a setting unit that sets an expectation value of a reduction in power purchased by the consumer from a system, on the basis of the remaining battery level information.

2. The electric power supply and demand control apparatus according to claim 1, wherein the setting unit that sets the expectation value for each consumer on the basis of the remaining battery level information of each consumer.

3. The electric power supply and demand control apparatus according to claim 1, further comprising a determination unit that determines a power purchase quantity adjustment plan in which the consumer to whom a request for a reduction in a power quantity purchased from a system is made is determined, on the basis of the expectation value which is set by the setting unit.

4. The electric power supply and demand control apparatus according to claim 3, wherein the determination unit extracts the consumer whose storage battery has a remaining battery level that is equal to or greater than a predetermined value on the basis of the remaining battery level information, and determines the consumer to whom the request is made from the extracted consumer.

5. The electric power supply and demand control apparatus according to claim 3, wherein the determination unit determines the power purchase quantity adjustment plan in which consumers to whom requests are made are determined so that a total sum of the expectation values of the consumers fails within a predetermined numerical range.

6. The electric power supply and demand control apparatus according to claim 1 further comprising an adjustment unit that requests the consumer to reduce a power quantity purchased from a system, and offers a predetermined incentive to the consumer in a case where a reduction reaches a predetermined value.

7. The electric power supply and demand control apparatus according to claim 1 further comprising:
a consumption prediction information acquisition unit that acquires consumption
prediction information Indicating a prediction of power consumed by the consumer for each time; and
a determination unit that determines the consumer to whom the request for a reduction in a power quantity purchased from a system, on the basis of the expectation value which is set by the setting unit and the consumption prediction information

8. The electric power supply and demand control apparatus according to claim 7, wherein the determination unit determines a power purchase quantity adjustment plan including a time slot at which the request for a reduction in a power purchase quantity is made to the determined consumer, and an expectation value of a reduction in power purchase for each of time slots.

9. The electric power supply and demand control apparatus according to claim 8, wherein the determination unit determines the power purchase quantity adjustment plan in which the expectation value of a reduction in power purchase of the consumer at each time slot is equal to or less than a prediction of power consumption quantity of the consumer at each time slot.

10. The electric power supply and demand control apparatus according to claim 8, wherein the determination unit determines the power purchase quantity adjustment plan in which a total sum of the expectation values of the reduction in power purchase of the consumer at each time slot is equal to or less than the expectation value of the consumer which is set by the setting unit.

11. The electric power supply and demand control apparatus according to claim 6, wherein with respect to a first consumer and a second consumer whose storage batteries have different remaining battery levels, the determination unit determines the power purchase quantity adjustment plan in which the expectation values of the reduction in power purchase are different from each other.

12. The electric power supply and demand control apparatus according to claim 8, wherein the determination unit determines the power purchase quantity adjustment plan in which time widths when the request for a reduction in a power purchase quantity is made to the first consumer and the second consumer whose storage batteries have different remaining battery levels are different from each other.

13. The electric power supply and demand control apparatus according to claim 8, wherein the determination unit determines the power purchase quantity adjustment plan in which time slots when the request for a reduction in a power purchase quantity is made to the first consumer and the second consumer having different consumption prediction information are different from each other.

14. The electric power supply and demand control apparatus according to claim 8, further comprising an incentive correspondence information acquisition unit that acquires incentive correspondence information indicating a change in a reduction in power purchase according to details of an offered incentive, for each consumer, wherein the determination unit further determines the power purchase quantity adjustment plan on the basis of the incentive correspondence information.

15. The electric power supply and demand control apparatus according to claim 7, wherein the consumption prediction information acquisition unit groups a plurality of consumers, and acquires the consumption prediction information for each group.

16. The electric power supply and demand control apparatus according to claim 1, wherein the setting unit further sets the expectation value on the basis of a history for each consumer indicating whether to comply with a request for a reduction in a power purchase quantity, a size of an incentive which is offered to the consumer when complying with the request for a reduction in a power purchase quantity, or a prediction of power consumption for each consumer at a time slot for which the request for a reduction in a power purchase quantity is made.

17. The electric power supply and demand control apparatus according to claim 16, wherein the larger a rate of complying with a request for a reduction in a power purchase quantity, the incentive, the remaining battery level of a storage battery, or the prediction of power consumption is, the larger expectation value the setting unit sets.

18. The electric power supply and demand control apparatus according to claim 1, wherein the setting unit groups a plurality of the consumers, and sets the expectation value for each group.

19. The electric power supply and demand control apparatus according to claim 18, wherein the setting unit groups the plurality of the consumers on the basis of registration information indicating details of each consumer, details of the storage battery, or a communication state of a terminal used by the consumer.

20. A non-transitory storage medium storing a program for causing a computer to function as:
a remaining battery level acquisition unit that acquires remaining battery level information indicating a remaining battery level of a storage battery of a consumer; and
a setting unit that sets an expectation value of a reduction in power purchased by the consumer from a system, on the basis of the remaining battery level information.

21. An electric power supply and demand control method executed by a computer, the method comprising:
a remaining battery level acquisition step of acquiring remaining battery level information indicating a remaining battery level of a storage battery of a consumer; and
a setting step of setting an expectation value of a reduction in power purchased by the consumer from a system performed, on the basis of the remaining battery level information.
